(19) United States
(12) Patent Application Publication
(10) Pub. No.: US 2005/0230887 A1
(43) Pub. Date: Oct. 20, 2005

(54) Undercarriage with a three-chamber shock absorber

(75) Inventors: Laurent Martinez, Montrouge (FR); Marc Gillet, Issy-les-Moulineaux (FR); Sebastien Gautrain, Jouy-en-Josas (FR); Maud Courtois, Paris (FR)

Correspondence Address: MCCORMICK, PAULDING & HUBER LLP, CITY PLACE II, 185 ASYLUM STREET, HARTFORD, CT, 06103, US

(73) Assignee: MESSIER-DOWTY SA, Velizy Villacoublay (FR)

(21) Appl. No.: 11/109,371

(22) Filed: Apr. 19, 2005

(30) Foreign Application Priority Data
Apr. 19, 2004 (FR) 0404092

(51) Int. Cl. F16F 5/00

(52) U.S. Cl. 267/64.26; 267/64.11

(57) ABSTRACT

The invention relates to landing gear including a shock absorber having fist and second elements slidable relative to each other, the slidable elements defining an inside volume which is filled in part with hydraulic fluid so as to leave a first chamber filled with gas under pressure and located at the end of one of the slidable elements. According to the invention, a vessel filled with gas under pressure is housed in the end and is provided with a shutter member that is initially in a closed state and that is suitable for taking up a stable open state when the pressure in the first chamber exceeds the pressure in the vessel by a predetermined threshold amount.

### BACKGROUND OF THE INVENTION

Undercarriages are known that include a shock absorber having first and second elements that are slidable relative to each other, said slidable elements defining an internal volume that is partially filled with hydraulic fluid so as to leave respective first and second chambers in the ends of the slidable elements, which chambers are filled with gas under pressure.

In general, the shock absorber includes a diaphragm secured to one of the elements and presenting throttling orifices through which the hydraulic fluid is forced in the event of a shock driving the elements towards each other. Such throttling dissipates a fraction of the kinetic energy of the airplane that has led to the shock absorber being compressed.

Another fraction of the kinetic energy is absorbed by compressing the gas contained in the chambers, given that said chambers decrease in volume during a shock.

For undercarriages situated beneath the fuselage of an airplane, it is important to ensure that the undercarriages cannot break their attachment points since that would run the risk of injuring passengers or of damaging fuel tanks.

It is known that the force transmitted by a shock absorber can be limited by providing structural portions designed to buckle when the force in the shock absorber exceeds a predetermined threshold. However such systems are difficult to design, and they require any buckled structural portions to be replaced before it is possible for the airplane to take off again, and that can interfere with regular service on the line provided by the airplane and can be awkward when the airplane is located at an airport that is remote and isolated.

### OBJECT OF THE INVENTION

An object of the invention is to provide a shock absorber provided with a safety device enabling the force transmitted by the shock absorber to be limited, and not requiring an immediate maintenance operation after the safety device has been triggered.

### BRIEF SUMMARY OF THE INVENTION

The invention provides an undercarriage including a shock absorber having a first element and a second element that are slidable relative to each other, said slidable elements defining an internal volume that is partially filled with hydraulic fluid so as to leave respective first and second chambers in the ends of the slidable elements, which chambers are filled with gas under pressure. According to the invention, the shock absorber includes a third chamber filled with gas and placed in series with the first chamber while being separated therefrom by a separator piston mounted to slide in sealed manner in the corresponding slidable element between an end-of-stroke abutment and the end of said slidable element.

Thus, when the pressure in the first chamber reaches a pressure equal to the inflation pressure of the third chamber, due to the shock absorber being compressed, the separator piston starts to move in such a manner that the pressures in the two chambers remain equal (ignoring the effects of the piston's friction and inertia).

The first and third chambers then behave as through they form a single chamber. The first chamber thus sees its volume increase by the volume of the third chamber, thereby tending to decrease the slope of the curve representing the force transmitted by the shock absorber, and as a result decreasing the maximum force that the shock absorber can transmit.

Thus, the third chamber represents a safety device that is very simple to implement. In addition, the separator piston itself returns to abutment when the pressure in the first chamber drops below the inflation pressure of the third chamber. The safety device of the invention therefore reinitializes itself automatically without requiring any maintenance action. Operation of the airplane is therefore not interrupted and it can continue to provide a commercial service.

Preferably, the separator piston is mounted to slide in leaktight manner on a central column having a free end that carries the end-of-stroke abutment.

In a particular aspect of the invention, the central column has a central duct opening out into the first chamber. In which case, the first chamber preferably contains a quantity of hydraulic fluid that is just sufficient to come flush with an inlet of the central duct.

In another particular aspect of the invention, the central column has an auxiliary duct opening out into the third chamber. In which case, the third chamber preferably contains a quantity of hydraulic fluid that is just sufficient to come flush with an inlet of the auxiliary duct.

### BRIEF DESCRIPTION OF THE DRAWING

The invention will be better understood in the light of the following description given with reference to the figures of the accompanying drawing, in which:

FIG. 1 is a longitudinal section view of a shock absorber of the invention; and

FIG. 2 is an enlarged view of FIG. 1 level with the gas bottle.

### DETAILED DESCRIPTION OF THE INVENTION

The invention is applied herein to a direct type undercarriage with an integrated shock absorber mounted under the fuselage of an airplane. Clearly the invention is not limited to undercarriages of this type, and is also applicable to undercarriages having an external shock absorber, and not necessarily mounted under the fuselage.

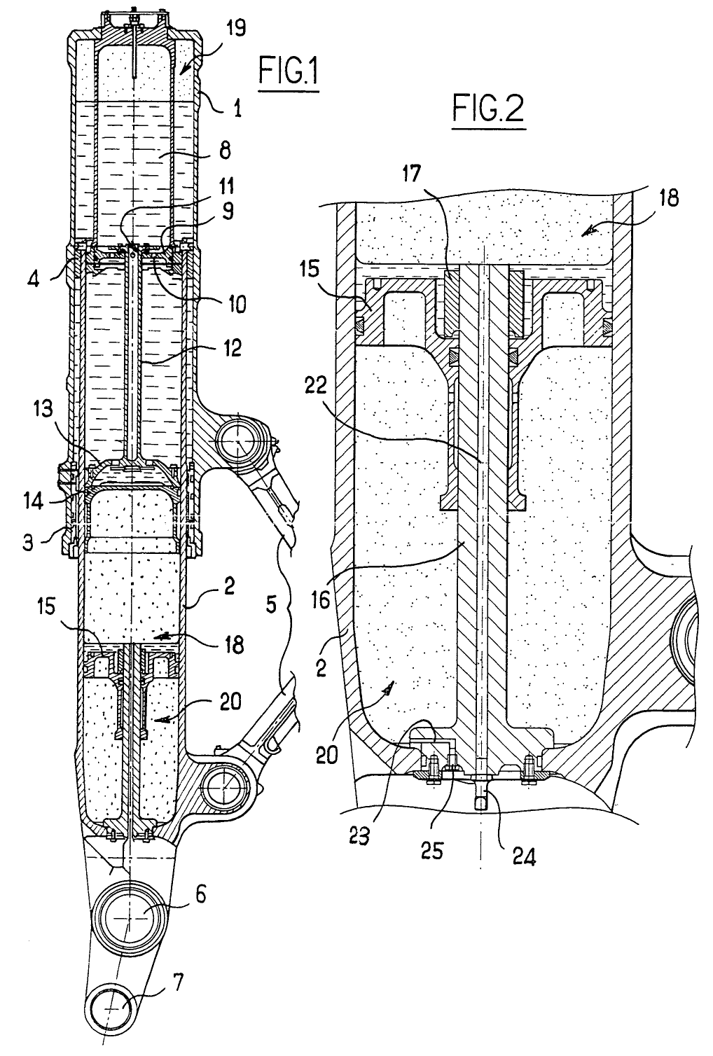

With reference to FIG. 1, and in conventional manner, the undercarriage comprises a main strut 1 connected to the airplane and having a rod 2 mounted to slide in leaktight manner therein. For this purpose, the strut carries a bottom bearing 3 in its lower portion with an inside surface in contact with the rod 2, and the rod 2 carries at its top portion a top bearing 4 with an outside surface in contact with the strut 1.

A scissors linkage 5 (of which only the ends of its two branches are visible) is mounted between the strut 1 and the rod 2 to prevent the rod 2 turning about its axis relative to the strut 1.

At its bottom end, the rod 2 forms a fork whose branches include bores 6 for receiving the hinge pin of a rocker beam carrying a plurality of wheels (not shown). In this example, the branches of the fork extend beyond the bores 6 in order to present bores 7 for receiving the ends of brake bars (not shown) for preventing angular movement of brake rings fitted to the wheels carried by the rocker beam.

A perforated tube 8 having its top end secured to the strut 1 extends inside it and carries at its bottom end a diaphragm 9 having an outside surface that slides in leaktight manner on the inside surface of the rod 2.

The diaphragm 9 has throttling orifices 10 and a central orifice 11 in which there extends a throttling needle 12 secured to the rod 2 via a support 13 fitted inside the rod 2 by means of a retaining ring and having through orifices.

A first separator piston 14 is mounted inside the rod 2 to slide in leaktight manner, the support 13 forming an end-of-stroke abutment for said separator piston 14.

A second separator piston 15 is disposed inside the rod 2 to slide in leaktight manner. As can be seen more clearly in FIG. 2, the second separator piston 15 slides on a column 16 secured to the end of the rod 2. The column 16 has an end-of-stroke abutment 17 at its top end for the second separator piston 15.

When the shock absorber is extended, as shown, hydraulic fluid (represented by horizontal dashes) completely fills the volume between the separator piston 14 and the diaphragm 9, and also the annular volume extending between the outside wall of the rod 2 and the inside wall of the strut 1, between the two bearings 3 and 4. Hydraulic fluid partially fills the volume that extends above the diaphragm 9.

The remainder of the internal volume of the shock absorber defines a first chamber 18 which extends between the first separator piston 14 and the second separator piston 15, and a second chamber 19 formed by the fraction of the volume above the diaphragm 9 that is not filled with hydraulic fluid, and a third chamber 20 arranged under the second separator piston 15. The third chamber 20 is thus disposed in series with the first chamber 18.

The first chamber 18 is filled with nitrogen (represented by dots) at a pressure of about 120 bars, while the second chamber 19 is filled with nitrogen at a pressure of about 20 bars. The third chamber 20 is inflated to a pressure of about 180 bars, i.e. a pressure greater than the inflation pressure of the adjacent first chamber 18.

When the shock absorber is extended, the first separator piston 14 is then in abutment against the support 13, while the second separator piston 15 presses against the abutment 17.

The shock absorber operates as follows.

During landing, the rod 2 is forced into the strut 1. As it happens, hydraulic fluid is forced to pass through the throttling orifices in the diaphragm 9. This throttling dissipates energy by internal friction in the hydraulic fluid. The quantity of hydraulic fluid passing through the diaphragm 9 decreases the volume of the second chamber 19 correspondingly, thereby compressing the nitrogen that is contained therein and increasing its pressure.

It should be observed that the fluid located above the diaphragm 9 is at a pressure that is imposed by the pressure that exists in the second chamber 19. As for the fluid located beneath the diaphragm 9, its pressure is determined by the resistance opposed to hydraulic fluid passing through the throttling orifices in the diaphragm 9. When this pressure reaches the inflation pressure of the first chamber 18, the first separator piston 14 begins to move, thereby compressing the gas in the first chamber 15.

The nitrogen contained in the chambers 18 and 19 thus behaves like a spring delivering force that corresponds to a relationship that is substantially polytropic.

Thereafter, the rod 2 is in a position of stable equilibrium inside the strut 1 under the effect of that fraction of the weight of the airplane to which the undercarriage is subjected. In the equilibrium position, the hydraulic fluid and the nitrogen contained in the two chambers 18 and 19 are at the same pressure.

Under certain circumstances, e.g. when the airplane is unevenly loaded, or in the event of a wing undercarriage failing while landing, the central undercarriage may need to support a large fraction of the weight of the airplane, in particular a weight exceeding the limits for which it was designed.

In order to ensure that the force exerted on the undercarriage does not exceed a dangerous level, the second separator piston 15 is suitable for moving when the pressure in the first chamber 18 reaches the inflation pressure of the third chamber 20.

When that happens, the shock absorber behaves as though the volume of the first chamber 18 had been instantaneously increased by the volume of the third chamber 20, thereby reducing the slope of the curve plotting the force transmitted by the shock absorber, and thereby reduces the maximum force that can be transmitted via the undercarriage.

The third chamber 20 constitutes a simple safety device, enabling the maximum forces transmitted via the undercarriage to be limited.

As soon as the pressure in the first chamber 18 drops back below the inflation pressure of the third chamber 20, the second separator piston 15 automatically goes back against the abutment 17. The safety device of the invention thus reinitializes itself automatically so that no maintenance is needed and the airplane continues to be capable of being used normally, even after the safety device has been triggered.

The movement of the second separator piston 15 causes the pressure in the third chamber 20 to rise, such that said movement is easily detected by means of a simple pressure sensor suitable for detecting when a pressure threshold is exceeded in the third chamber 20.

In a particular aspect of the invention, the column 16 includes a central duct 22 which opens out into the first chamber 18, thus making it easy to inflate said first chamber from outside the strut, via an inflation valve 24.

Another inflation valve (not shown) is placed directly on the rod 2 to enable the third chamber 20 to be inflated.

In another particular aspect of the invention, the second chamber 18 contains a small quantity of hydraulic fluid, just enough to lie flush with the top end of the column 16, and thus the inlet of the central duct 22. The sealing gaskets on the second separator piston 15 thus continue to be wetted by the hydraulic fluid, which prevents them from drying out. In addition, in the event of the sealing gasket of the first separator piston 14 failing, the leakage of hydraulic fluid resulting from such failure flows into the first chamber 18. The entire leakage then spills into the central duct 22 of the column 16 because the top end of the column 16 is flush with the hydraulic fluid already present in the first chamber 18.

Thus, by means of the central duct 22, maintenance performed on the first chamber 18 can detect a failure of the sealing gasket of the first separator piston 14.

Similarly, the third chamber 20 contains a small quantity of hydraulic fluid, just enough to be flush with the inlet of an auxiliary duct 23 formed in the bottom of the column 16 and closed by a bleed screw 25. The presence of hydraulic fluid in the auxiliary duct 23, as detected during a maintenance operation, constitutes an indication that one of the sealing gaskets of the second separator piston 15 has failed.

The invention is not limited to the particular embodiments of the invention described above, but on the contrary covers any variant coming within the ambit of the invention as defined by the claims.

1. An undercarriage including a shock absorber having a first element and a second element that are slidable relative to each other, said slidable elements defining an internal volume that is partially filled with hydraulic fluid so as to leave respective first and second chambers in the ends of the slidable elements, which chambers are filled with gas under pressure, wherein the shock absorber includes a third chamber filled with gas and placed in series with the first chamber while being separated therefrom by a separator piston mounted to slide in sealed manner in the corresponding slidable element between an end-of-stroke abutment and the end of said slidable element.

2. An undercarriage according to claim 1, wherein the separator piston is mounted to slide in sealed manner on a central column having a free end carrying the end-of-stroke abutment.

3. An undercarriage according to claim 2, wherein the central column has a central duct opening out into the first chamber.

4. An undercarriage according to claim 3, wherein the first chamber contains a quantity of hydraulic fluid that is just sufficient to be flush with an inlet of the central duct.

5. An undercarriage according to claim 2, wherein the central column includes an auxiliary duct opening out into the third chamber.

6. An undercarriage according to claim 5, wherein the third chamber contains a quantity of hydraulic fluid that is just sufficient to be flush with an inlet of the auxiliary duct.
